(19) United States
(12) Patent Application Publication
(10) Pub. No.: US 2007/0113165 A1
(43) Pub. Date: May 17, 2007

(54) Multimedia playing system and method

(76) Inventors: Yi-Hsin Hsieh, Taipei (TW); Vam Chang, Taipei (TW)

Correspondence Address: PEARL COHEN ZEDEK LATZER, LLP, 1500 BROADWAY 12TH FLOOR, NEW YORK, NY, 10036, US

(21) Appl. No.: 11/392,778

(22) Filed: Mar. 30, 2006

(30) Foreign Application Priority Data
Nov. 15, 2005 (TW) 94140023

(51) Int. Cl. G06F 17/00

(52) U.S. Cl. 715/500.1

(57) ABSTRACT

A multimedia playing method and system are proposed. The system at least has a main section and a remote section having a fingerprint identifying function. The main section has a database for storing identification data of multimedia contents, pausing points of the multimedia contents indicating the point at which the contents were previously paused when played and corresponding user identifications. The remote section acquires a fingerprint of a current user as the user identification, the multimedia content to be played and the user's instructions, which are transmitted to the main section. The main section then searches in its database for a pausing point of the multimedia content to be played corresponding the user identification. Then, the multimedia content is played from the pausing point for the particular user.

### FIELD OF THE INVENTION

The present invention relates to a multimedia playing technique, and more particularly, to a multimedia playing system and method for automatically and continuously playing multimedia contents.

### BACKGROUND OF THE INVENTION

When a disc is played on a machine, different people may not watch it at the same time, or even may not finish watching the whole content at one time. Thus, when one wishes to continue watching from where she/he left off, she/her has to manually forward the content to previous pausing point, this is not only time consuming but also troublesome in finding the correct pausing point.

In view of the above deficiency, some manufacturers have developed players with playing position memorizing function, such that when a “stop” instruction is received, the player can memorize the present playing position of the disc, so that next time the disc is played from the memorized playing position, thereby allowing multimedia content to be played continuously. However, one disadvantage of this technique is that: when several people have watched the film successively, the player can only memorize the playing record for the last user, so it lacks flexibility in memorizing more than one user's playing record.

Accordingly, yet another design has been proposed that provides players with multiple playing records for multiple users, but the problem with this technique is that users need to manually search for his/her own playing record in a specific database, which is complicated to operate, and hard to find the required playing record when the amount of records are large. As a result, the memorizing function cannot be brought into full play.

Therefore, there is a need to solve the above described shortcomings.

### SUMMARY OF THE INVENTION

In the light of forgoing drawbacks, an objective of the present invention is to provide a multimedia playing method and system that searches corresponding playing records based on user identification acquire through fingerprints of the users, so that multimedia contents can be played continuously.

Another objective of the present invention is to provide a multimedia playing method and system that enhances accuracy and simplicity for continuously playing multimedia contents.

Still another objective of the present invention is to provide a multimedia playing method and system that allows a plurality of users to watch the same multimedia content in a same multimedia player starting from different points of the content using respective playing records identified via user's unique fingerprints.

In accordance with the above and other objectives, the present invention proposes a multimedia playing system and method. The multimedia playing system comprises a remote section for inputting a user's instructions and acquiring a fingerprint of the user as a unique user identification; and a main section for manipulating multimedia contents, and if the multimedia content is paused during playing, recording an identification data and a pausing point of a multimedia content and the corresponding user identification. The multimedia content can be played from a disc or a hard disk of the main section.

In one embodiment, the main section further comprises a database; a communicating interface for receiving the user identification and instructions sent by the remote section; a playing unit for playing the multimedia content from the beginning thereof or the pausing point; a recording unit for recording the identification data and the pausing point of the multimedia content being played and the corresponding user identification in the database if the multimedia content being paused during playing; and a search unit for searching the pausing point of the multimedia content in the database according to the user identification.

In one embodiment, the remote section further comprises a fingerprint database for storing fingerprint images of the users; a setting unit composed of a plurality of functional keys for allowing the users to input instructions; and a transmitting interface for transmitting instructions and the corresponding user identification to the main section.

The multimedia playing method of the present invention performs multimedia playing operation comprises the following steps:

(1) establishing a database with at least one entry of an identification data of a multimedia content, a pausing point and a corresponding user identification;

(2) acquiring a fingerprint of the current user and the multimedia content to be played;

(3) searching a pausing point of the multimedia content to be played based on the user's fingerprint as the user identification; and

(4) playing the multimedia content from the pausing point.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing the basic structure of a multimedia playing system of the present invention;

FIG. 2 is a flowchart showing a multimedia playing method of the present invention in which a new multimedia content is to be played; and

FIG. 3 is a flowchart showing the multimedia playing method of the present invention in which the multimedia content to be played has been recorded previously.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

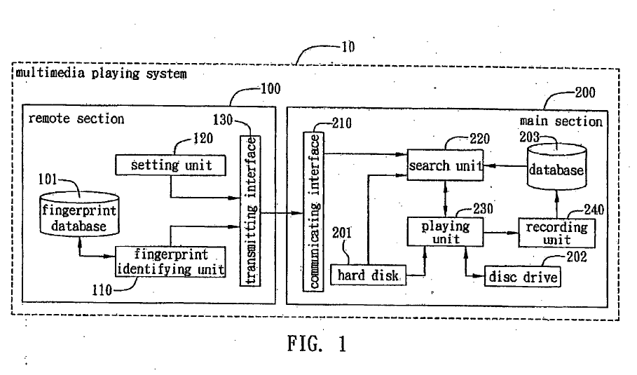

FIG. 1 is a schematic block diagram showing the basic structure of a multimedia playing system 10 of the present invention. As shown, the multimedia playing system 10 comprises a remote section 100 and a main section 200. In this embodiment, the main section 200 can be a DVD and/or VCD player; the remote section 100 includes a fingerprint database 101, a fingerprint identifying unit 110, a setting unit 120 and a transmitting interface 130.

The fingerprint database 101 is used to store user identification data and corresponding fingerprint images.

The fingerprint identifying unit 110 is used to receive the current user's fingerprint and searches for the corresponding user identification data in the fingerprint database 101, wherein, the remote section 100 may further comprise a sensing unit (not shown) for physically acquiring an image of the fingerprint of a current user, such that the fingerprint identifying unit 110 can search for the corresponding user identification data in the fingerprint database 101 based on the acquired fingerprint image. The setting unit 120 is composed of a plurality of function keys for allowing users to enter functional instructions. In this embodiment, the setting unit 120 is a functional key zone in the remote section 100 for allowing users to select the multimedia content to be played and operate functions such as “play”, “stop”, “forward” and “backward” etc.

The transmitting interface 130 is used to transmit the functional instructions inputted by a user along with user's identification to the main section 200. The main section 200 comprises a hard disk 201, a disc drive 202, a database 203, a communicating interface 210, a search unit 220, a playing unit 230 and a recording unit 240.

As shown in FIG. 1, the main section 200 executes a play program by reading data in a multimedia disc, that is, the multimedia disc is first inserted into the disc drive 202, the data on the disc is then read via an optical head (not shown), and the multimedia play program is executed. Alternatively, the main section 200 may read multimedia contents stored in the hard disk 201 of the main section 200 and execute the multimedia play program.

The database 203 is used to store identification data for current multimedia content, continuous playing position and the corresponding user identification data (to be described later).

The communicating interface 210 is used to receive the user identification data and the instructions for the multimedia content to be played from the remote section 100.

The search unit 220 is used to search for a corresponding pausing point in the database 203 based on the user identification data and a “play” instruction received by the communicating interface 210. The pausing point indicates the point at which a playing multimedia content was paused. In this embodiment, the user first inserts a DVD into the disc drive 202 and enters a “play” instruction via the setting unit 120. As a result, the main section receives the “play” instruction along with the fingerprint image of the current user. Thereafter, the main section 200 detects the identification data of the disc, for example, a text description of “Superman” (or an ID code), then searches for a multimedia content which has “Superman” as the identification data and the matching fingerprint image as the user identification data in the database 203. At the same time, the pausing point, if available, is obtained. For example, the pausing point may be “33:04” indicating a time point of the multimedia content The playing unit 230 is used to play the multimedia content searched by the search unit 220; i.e. in this embodiment, the multimedia content is played from the time of “33:04”.

The recording unit 240 is used to record (or update) identification data of the multimedia content being played, current playing position and the user identification data into the database 230 when a user actuates a “stop (or pause)” instruction during playing executed by the playing unit 230.

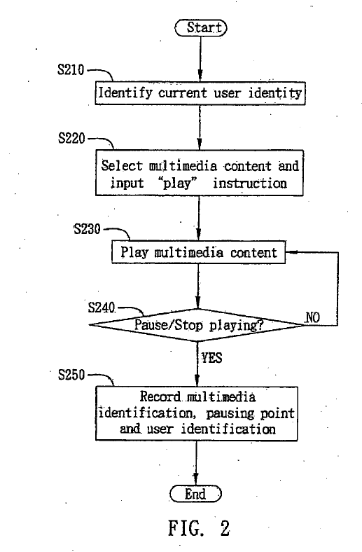

FIG. 2 is a flowchart showing the multimedia playing method of the present invention in which a new multimedia content is to be played. As shown, step S210 is performed. When a user enters an instruction through the remote section 100, the fingerprint identifying unit 110 identifies the user's identification based on the fingerprint or stores it into the fingerprint database 101 if it is a new fingerprint. Then, step S220 is performed.

In step S220, the user may select a multimedia content from the disc drive or the hard disk and inputs a “play” instruction via the setting unit 120 of the remote section 100, which is then transmitted to the main section 200. Next, step S230 is performed.

In step S230, the multimedia content is played based on the “play” instruction specified by the user. Then, step S240 is performed.

In step S240, it is determined whether a “stop (or pause)” instruction has been received by the main section 200 during multimedia content playing, if so, step S250 is performed; else, step S230 is repeated.

In step S250, the main section 200 reads and records in the database 230 the identification data of the multimedia content currently being played, the current playing position and the user's identification data who sent out the “stop (or pause)” instruction.

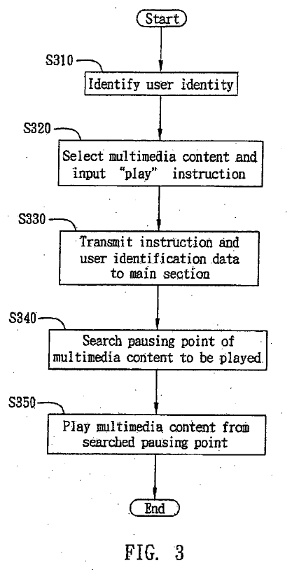

FIG. 3 is a flowchart showing the multimedia playing method of the present invention in which the multimedia content to be played has been recorded previously.

First, step S310 is performed. When a user enters an instruction through the remote section 100, the fingerprint identifying unit 110 identifies the user's identification based on the fingerprint. Then, step S320 is performed.

In step S320, the user may select a multimedia content from the disc drive or the hard disk and inputs a “play” instruction via the setting unit 120 of the remote section 100. Next, step S330 is performed.

In step 330, the “play” instruction and the corresponding user identification data are transmitted from the remote section 100 to the main section 200. Then, step S340 is performed.

In step S340, upon receiving the “play” instruction and the user identification data, the main section 200 searches the database 203 for the pausing point of the selected multimedia content based on the user's identification. In this embodiment, a pausing point “33:04” is obtained. Then, step S350 is performed.

In step S350, the main section 200 plays the multimedia content from the obtained pausing point.

In summary, the multimedia playing method of the present invention has the following and other advantages: a plurality of users can be identified by employing the fingerprint images and a multimedia content can be continuously played from where it has previously been stopped/paused by recording the pausing point of the multimedia content and the corresponding current user identification data in the database. Accordingly, time to search the previous pausing point is eliminated and the same multimedia content can be played from different pausing points according to different users.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A multimedia playing system, comprising:
a remote section for inputting a user's instructions and acquiring a fingerprint of the user as a unique user identification; and
a main section for manipulating multimedia contents, and if the multimedia content is paused during playing, recording an identification data and a pausing point of a multimedia content and the corresponding user identification.

2. The multimedia playing system of claim 1, wherein the multimedia content to be played is stored in at least one of a disc and a hard disk of the main section.

3. The multimedia playing system of claim 1, wherein the main section further comprises:
a database;
a communicating interface for receiving the user identification and instructions sent by the remote section;
a playing unit for playing the multimedia content from the beginning thereof or the pausing point;
a recording unit for recording the identification data and the pausing point of the multimedia content being played and the corresponding user identification in the database if the multimedia content being paused during playing; and
a search unit for searching the pausing point of the multimedia content in the database according to the user identification.

4. The multimedia playing system of claim 1, wherein the remote section further comprises:
a fingerprint database for storing fingerprint images of the users;
a setting unit composed of a plurality of functional keys for allowing the users to input instructions; and
a transmitting interface for transmitting instructions and the corresponding user identification to the main section.

5. A multimedia playing method for performing multimedia playing operation, the method comprising the following steps:
(1) establishing a database with at least one entry of an identification data of a multimedia content, a pausing point and a corresponding user identification;
(2) acquiring a fingerprint of the current user and the multimedia content to be played;
(3) searching a pausing point of the multimedia content to be played based on the user's fingerprint as the user identification; and
(4) playing the multimedia content from the pausing point.

6. The multimedia playing method of claim 5, wherein the multimedia content to be played is stored in at least one of a disc and a hard disk.
